(19) United States
(12) Patent Application Publication
(10) Pub. No.: US 2006/0285628 A1
(43) Pub. Date: Dec. 21, 2006

(54) Fuel assembly for a pressurized-water nuclear reactor, and a core of a pressurized-water nuclear reactor which is composed of fuel assemblies of this type

(75) Inventors: Jurgen Stabel, Erlangen (DE); Hans-Peter Fuchs, Nurnberg (DE); Mingmin Ren, Erlangen (DE)

Correspondence Address: LERNER GREENBERG STEMER LLP, P O BOX 2480, HOLLYWOOD, FL, 33022-2480, US

(73) Assignee: Framatome ANP GmbH

(21) Appl. No.: 11/435,217

(22) Filed: May 16, 2006

Related U.S. Application Data
(63) Continuation of application No. PCT/EP04/13817, filed on Dec. 4, 2004.

(30) Foreign Application Priority Data
Dec. 16, 2003 (DE) 103 58 830.2

(51) Int. Cl. G21C 3/32

(52) U.S. Cl. 376/435

(57) ABSTRACT

A fuel assembly for a pressurized-water nuclear reactor contains a plurality of grid-shaped, square spacers spaced apart from one another. Each of the grid-shaped, square spacers has four edge webs. At least one of the spacers has at least two differently configured edge webs for generating a force which acts from a flowing cooling water on the fuel assembly in a plane of the spacer transversely with respect to an axial direction. A multiplicity of fuel rods extend in the axial direction and are guided in the plurality of grid-shaped, square spacers.

### CROSS REFERENCE TO RELATED APPLICATION

This is a continuing application, under 35 U.S.C. §120, of copending international application No. PCT/EP2004/013817, filed Dec. 4, 2004, which designated the United States; this application also claims the priority, under 35 U.S.C. §119, of German patent application No. 103 58 830.2, filed Dec. 16, 2003; the prior applications are herewith incorporated by reference in their entirety.

### BACKGROUND OF THE INVENTION

### Field of the Invention

The invention relates to a fuel assembly for a pressurized-water nuclear reactor and to a core of a pressurized-water nuclear reactor which is constructed using a fuel assembly of this type.

It is known from numerous inspection results that the fuel assemblies of a pressurized-water nuclear reactor, over their period of use, bend as a function of their position in the core, so that systematic bending patterns may result for the entire core. The bending may have various causes, for example an anisotropy in the thermal expansion or an increase in length, induced by radioactive radiation, of the fuel rod cladding tubes or the control rod guide tubes. However, the main reasons for the bending are assumed in particular to be an interaction between the flowing cooling water and the fuel assembly and inhomogeneities in the flow of the cooling water into and out of the core. The systematic bending produces larger gaps at certain, but in many cases unknown, points in the core between the individual fuel assemblies or between the fuel assemblies which are located at the edge of the core and the core shroud, in which gaps the cooling water used as a moderator flows. In unfavorable circumstances, this may have an effect on configuration limits. If these locations with gaps of increased size were known, it would be possible to compensate for the increased moderation there by deliberately using fuel assemblies or fuel rods with a lower power or enrichment at these locations.

### SUMMARY OF THE INVENTION

It is accordingly an object of the invention to provide a fuel assembly for a pressurized-water nuclear reactor, and a core of a pressurized water nuclear reactor which is composed of fuel assemblies of this type that overcomes the above-mentioned disadvantages of the prior art devices of this general type, which despite bending that occurs, allows an optimized configuration of the core. The invention is also based on the object of specifying an optimized core constructed with the aid of a fuel assembly of this type.

In a fuel assembly for a pressurized-water nuclear reactor, a multiplicity of fuel rods which extend in the axial direction are guided in a plurality of grid-like, square spacers. The spacers are spaced apart from one another and the edge of which is in each case formed by four edge webs. At least one spacer has at least two differently configured edge webs for generating a force which acts from the flowing cooling water on the fuel assembly in the plane of the spacer transversely with respect to the axial direction.

As a result of the fuel assembly being configured in this way, the forces exerted on the fuel assembly as a result of the coolant flowing between the edge webs of respectively adjacent fuel assemblies or between the edge web of an outer fuel assembly and the core shroud, are dependent on the configuration of the edge webs and act asymmetrically on the fuel assembly. The resulting force acting transversely with respect to the axial direction is known on account of the configuration of the edge webs, and consequently the deformations which occur as a result of the fluid-structure interactions can also be predicted and influenced in a targeted way. It is in this way possible to produce targeted bending of a fuel assembly and therefore also a targeted bending pattern of a core composed of fuel assemblies of this type or a subregion of the core. Therefore, the positions at which the large water gaps which are established occur are known in advance, so that fuel assemblies with a correspondingly low power can be deliberately used there. It is in this way possible to reliably ensure that the core configuration parameters are complied with.

The invention is based on the consideration that the forces which act on a fuel assembly in the plane of a spacer are substantially caused by the pressure difference which is established on account of the different flow velocities of the cooling water in the gap between the spacers and within the fuel assembly. This pressure difference can be influenced by simple configuration measures at the edge webs, so that it is easily possible to set the pressure differences which in each case result between the fuel assembly at the adjoining water gaps and therefore to influence the net force acting on the fuel assembly in a targeted way.

In one preferred embodiment, the two differently configured edge webs lie opposite one another, so as to generate a net force on the fuel assembly which runs transversely with respect to the axial direction of the fuel assembly and approximately perpendicular to these two edge webs if the other two edge webs are of identical construction. If the other two opposite edge webs also differ, the net force may also run obliquely with respect to the edge webs, in which case the angle can be set according to the configuration.

In a further preferred configuration of the invention, the two differently configured edge webs differ by virtue of the fact that they have a different number, shape and/or arrangement of openings.

As an alternative or in addition, it is also possible for the two differently configured edge webs to have different mixing or deflecting vanes. This likewise produces an asymmetry in the pressure differences which occur between gap and fuel assembly, so that in this case too a resulting transverse force remains, the extent and direction of which influences the bending of the fuel assembly in a targeted way.

In a preferred configuration of the invention, the at least one spacer is disposed in the center region of the fuel assembly. This allows particularly effective influencing of the bending, since a transverse force which acts on the fuel assembly in the center region influences the extent of bending to the maximum extent.

In accordance with a further embodiment of the invention, the fuel assemblies according to the invention are disposed in a core of this type in such a manner that the forces acting on the fuel assemblies transversely with respect to the axial direction are at least approximately parallel to one another. This produces a targeted, systematic bending which acts in a single direction and clearly defines the position of the largest water gaps.

It is preferable for the fuel assemblies disposed in an edge region of the core which is remote from the force which is acting to have a lower power than the fuel assemblies in the other edge regions. It is in this way possible to compensate for the greater moderation which occurs in the region of the large water gaps.

Other features which are considered as characteristic for the invention are set forth in the appended claims.

Although the invention is illustrated and described herein as embodied in a fuel assembly for a pressurized-water nuclear reactor, and a core of a pressurized water nuclear reactor which is composed of fuel assemblies of this type, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a core of a pressurized-water nuclear reactor according to the invention;

FIG. 2 is a diagrammatic, longitudinal section view through the core and taken along the line II-II shown in FIG. 1;

FIG. 3 is a diagrammatic partial perspective view of adjacent fuel assemblies, one of which is configured in accordance with the invention.

### DESCRIPTION OF THE EMBODIMENTS

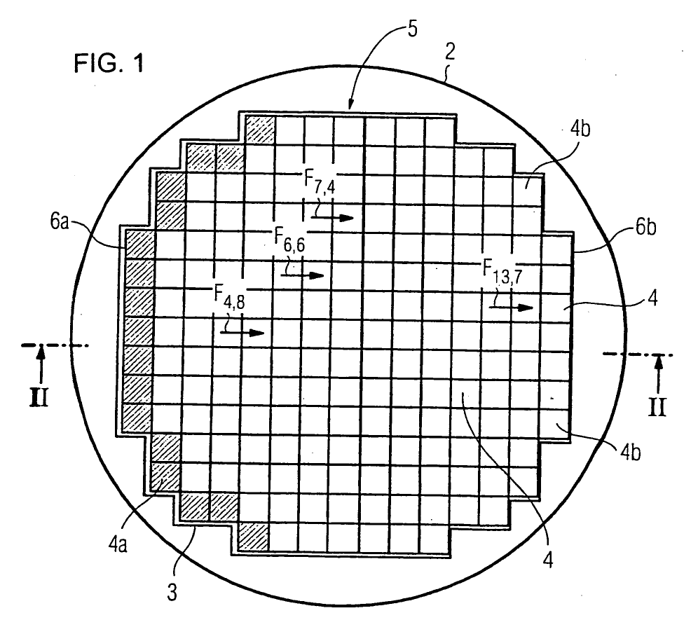

Referring now to the figures of the drawing in detail and first, particularly, to FIG. 1 thereof, there is shown a core 5 constructed from a multiplicity of fuel assemblies 4 which are square in cross section and disposed within a core shroud 3 fixed in a core barrel 2. FIG. 1 shows a diagrammatic, cross-sectional view approximately through the middle of the core. It can be seen from the FIG. 1 that the entire core 5, in the center, is bent to the right, which leads to a larger water gap 6a between fuel assemblies 4a located at a left-hand edge and indicated by hatching and the core shroud 3 located on the left. A water gap 6b between fuel assemblies 4b located at a right-hand edge and the core shroud 3 is correspondingly reduced. The core 5 therefore overall has a systematic bending, indicated very diagrammatically in FIG. 1, toward the right-hand edge. This is caused by directed forces F_{i,j} which are exerted on at least some of the fuel assemblies 4 and may differ from one another in terms of magnitude according to the position i,j of the fuel assembly 4 in the core 5, but are at least approximately parallel to one another. For the sake of clarity, FIG. 1 only indicates the forces F_{i,j} acting on the fuel assemblies 4 in positions (4,8), (6,6), (7,4) and (13,7).

To compensate for the increased moderation in the gap 6a, in an advantageous configuration of the core 5, it is possible for the fuel assemblies 4a which are disposed in the edge region remote from the forces F_{i,j} which are acting to have a lower power than the fuel assemblies 4b in the other edge regions.

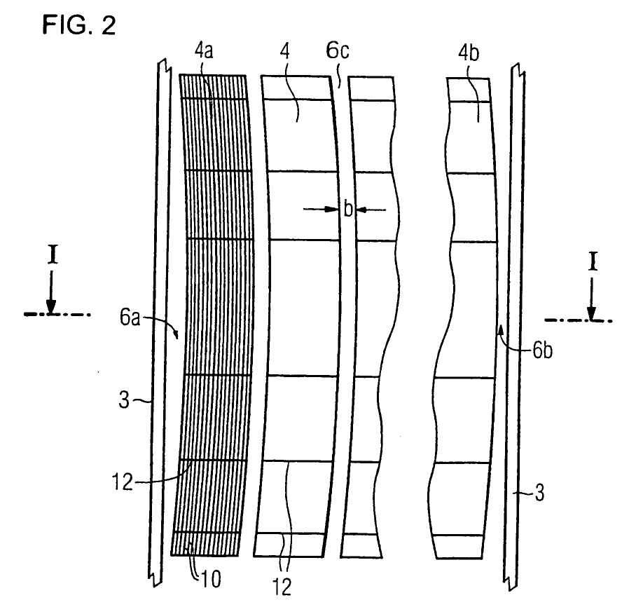

The situation which is present in the core 5 can be seen more clearly in the longitudinal sectional view shown in FIG. 2. It can be seen from the longitudinal section view that the fuel assemblies 4 have an identically directed, C-shaped bending which has scarcely any influence on a width b of the gap 6c between the individual fuel assemblies 4. In other words, the gap width b remains virtually constant over the entire length of the fuel assembly 4 and approximately corresponds to the gap width which is present in the initial state of fresh, unbent fuel assemblies. However, the systematic bending of the fuel assemblies 4 does lead to an increased water gap 6a between the fuel assembly 4a located at the edge and the core shroud 3 and to a correspondingly reduced water gap 6b between the core shroud 3 and the fuel assembly 4b located at the right-hand edge.

As seen in the axial direction, in each case a multiplicity of fuel rods 10 are disposed in the fuel assemblies 4, guided in square grid-like spacers 12. For the sake of clarity, the spacers 12 are illustrated only very diagrammatically, and the fuel rods 10 are likewise illustrated, in a diagrammatically simplified representation, only in the left-hand fuel assembly 4a.

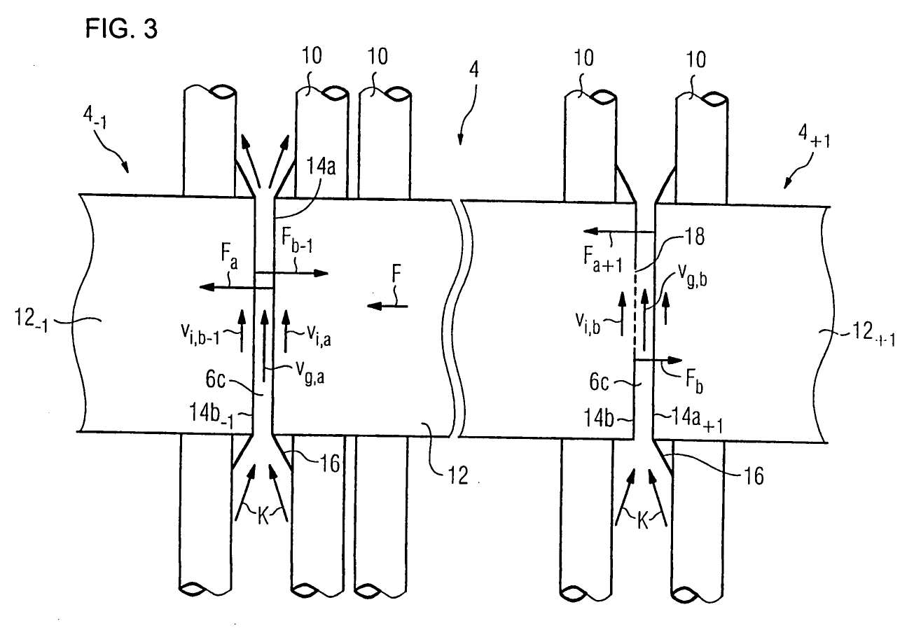

A fuel assembly 4 in the region of its spacer together with adjacent fuel assemblies 4₋₁, 4₊₁ is illustrated in FIG. 3. In FIG. 3, the middle fuel assembly 4 is now configured in accordance with the invention and has a spacer 12, the opposite edge webs 14a, 14b of which are configured differently from one another. In the exemplary embodiment, the edge web 14a is smooth-walled, i.e. is not provided with openings, and at each of its end sides has mixing vanes 16, which lead to more of the cooling water K, which flows in from below, being introduced into the gap 6c between the edge webs 14b₋₁, 14a of the adjacent fuel assemblies 4, 4₋₁. In the gap 6c, the cooling water K is accelerated, so that on account of the velocity v_{g,a} which is established in the gap 6c, on the one hand, and the velocities v_{i,a} and v_{i,b-1} in the interior of the spacer 12 and 12₋₁, respectively, pressure differences are built up, generating a force Fa acting on the fuel assembly 4 and a force F_{b-1} acting on the fuel assembly 4₋₁ (generalized Bernoulli effect).

FIG. 3 now illustrates a situation in which the adjacent edge webs 14a, 14b₋₁ are of identical configuration. This would lead to the two forces Fₐ and F_{b-1} being equal in magnitude, with the result that the forces acting on the fuel assembly 4 in the plane of the spacer 12, given a symmetrical configuration of the spacer 12 and assuming that the inflow conditions do not change significantly between the opposite edge webs 14a and 14b, would compensate for one another.

According to the invention, there is now provision for at least two edge webs of the spacer 12, in the example the edge web 14a and the opposite edge web 14b, to be configured differently from one another, as illustrated in the example presented in FIG. 3 by openings 18 indicated by dashed lines and by a mixing vane being absent in the inflow region. Both measures, which can be used either as alternatives to one another or in combination with one another, now cause the difference which is established between the velocity v_{g,b} in the gap 6c between the spacers 12 and 12₊₁ and the velocity v_{i,b} in the interior of the fuel assembly 12 to be reduced, so that the force F_{b} exerted on the fuel assembly 12 on this side is lower than the oppositely directed force Fₐ which is exerted on the opposite side. Therefore, a net force F=Fₐ−F_{b}, which leads to controlled bending of the fuel assembly 4, acts on the fuel assembly in the region of the spacer 12. At the edge web 14a₊₁, a force Fₐ₊₁, which on account of the altered flow conditions in the right-hand gap 6c does not correspond to the force Fₐ acting on the fuel assembly 12, now acts on the fuel assembly 12₊₁. In order also to produce a net force acting to the left on the fuel assembly 12₊₁, its right-hand edge web, which is no longer illustrated in FIG. 3, likewise has to be provided with measures for reducing the pressure difference between the gap and the interior of the fuel assembly 12₊₁ analogously to the measures illustrated at the edge web 14b. If all the spacers which are located in one plane, for example the center plane of the core, are constructed in the same way as the spacer 12 (in which case the edge web 14b₋₁, contrary to what is illustrated in FIG. 3, would need to be configured in the same way as the edge web 14b), a force acting to the left is exerted on all the fuel assemblies, and systematic bending of the core which is mirror-symmetrical with respect to the exemplary embodiments illustrated in FIGS. 1 and 2 is established.

On account of the different inflow conditions into the core and outflow conditions out of the core it is, in some cases, expedient for the asymmetric spacers to be configured differently depending on the position of the fuel assembly in the core or for the number of these spacers in the fuel assembly to be varied, i.e. for a plurality of asymmetric spacers to be provided in one fuel assembly, in order to systematically influence its bending in a manner adapted to the local conditions at its position in the core.

We claim:

1. A fuel assembly for a pressurized-water nuclear reactor, comprising:
a plurality of grid-shaped, square spacers spaced apart from one another and each having four edge webs, at least one of said spacers having at least two differently configured edge webs for generating a force acting from a flowing cooling water on the fuel assembly in a plane of said spacer transversely with respect to an axial direction; and
a multiplicity of fuel rods extending in the axial direction and guided in said plurality of grid-shaped, square spacers.

2. The fuel assembly according to claim 1, wherein said two differently configured edge webs lie opposite one another.

3. The fuel assembly according to claim 1, wherein said two differently configured edge webs differ by virtue of having a different number, shape and/or configuration of openings formed therein.

4. The fuel assembly according to claim 1, wherein said two differently configured edge webs have different mixing vanes.

5. The fuel assembly according to claim 1, wherein said at least one spacer is disposed in a center region of the fuel assembly.

6. A core of a pressurized-water nuclear reactor, comprising:
a plurality of fuel assemblies disposed such that forces acting on said fuel assemblies transversely with respect to an axial direction being at least approximately parallel to one another, each of said fuel assemblies containing:
a plurality of grid-shaped, square spacers spaced apart from one another and each having four edge webs, at least one of said spacers having at least two differently configured edge webs for generating a force acting from a flowing cooling water on the fuel assembly in a plane of said spacer transversely with respect to the axial direction; and
a multiplicity of fuel rods extending in the axial direction and guided in said plurality of grid-shaped, square spacers.

7. The core according to claim 6, wherein said fuel assemblies disposed in an edge region of the core, which is remote from the force which is acting, have a lower power than said fuel assemblies in other edge regions of the core.
